(19) United States
(12) Patent Application Publication
(10) Pub. No.: US 2026/0170724 A1
(43) Pub. Date: Jun. 18, 2026

(54) SYSTEM AND METHOD FOR GENERATING A WALL OF ARTWORK

(71) Applicant: Artfully Walls LTD, Ra’anana (IL)

(72) Inventors: Sagiv PHILIPP, Ra'anana (IL); Naama SLOMIANSKY, Jerusalem (IL)

(73) Assignee: Artfully Walls LTD, Ra’anana (IL)

(21) Appl. No.: 18/986,257

(22) Filed: Dec. 18, 2024

(51) Int. Cl. G06T 11/60

(52) U.S. Cl. CPC G06T 11/60; G06T 2211/441

(57) ABSTRACT

A system and method for generating a wall of artwork using at least one machine learning model are provided herein. The system and method include: generating a sequence of tokens that corresponds to a layout, where the layout includes outlines allocated for and corresponding to a number of requested artworks; generating artwork embeddings of a plurality of artworks; sequentially selecting artworks to be placed in respective outlines in the layout based on the sequence of tokens in the layout the artwork embeddings of the previously selected artworks, where the selected artworks meet a pre-determined threshold of artistic quality; and displaying the requested wall of artworks, where the wall of artworks is a visual display of pieces of art arranged on a surface.

### TECHNICAL FIELD

The present disclosure relates generally to a system and method using artificial intelligence models to generate a wall of artwork.

### BACKGROUND

Artificial intelligence (AI) systems for arranging a series of artworks on a wall involve AI models that determine both the arrangement of the artwork and the specific pieces to be included in that arrangement. These systems select existing artworks and decide how they should be displayed together to form a cohesive and visually appealing layout.

One significant problem with these AI systems is that they often generate arrangements that are of low quality and lack aesthetic appeal. This can result in errors where artworks overlap, are arranged haphazardly, or lack symmetry, leading to a visually unpleasing display. The AI system's inability to consistently produce harmonious and well-organized layouts can detract from the overall impact of the artwork.

Another issue is that these AI systems may not always select the most suitable artworks for the arrangement. This can happen because the AI system lacks a deep understanding of the artistic relationships between different pieces, resulting in selections lack artistic cohesion when combined. The chosen artworks might clash in style, theme, or color, creating a disjointed and incoherent display that fails to convey a unified artistic vision.

Additionally, these AI systems often struggle with understanding the spatial relationships within the arrangement. This lack of spatial awareness can lead to poor placement of artworks, where the pieces do not complement each other or the surrounding space. The result is an arrangement that is unbalanced, further diminishing the aesthetic quality of the display.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating walls of artworks using at least one machine learning model. The method includes: generating a sequence of tokens that corresponds to a layout, wherein the layout includes outlines allocated for and corresponding to a number of requested artworks; generating artwork embeddings of a plurality of artworks; sequentially selecting artworks to be placed in respective outlines in the layout based on the sequence of tokens in the layout the artwork embeddings of the previously selected artworks, wherein the selected artworks meet a pre-determined threshold of artistic quality; and displaying the requested wall of artworks, wherein the wall of artworks is a visual display of pieces of art arranged on a surface.

Certain embodiments disclosed herein also include a non-transitory computer readable medium having stored thereon causing a processing circuitry to execute a process, the process including: generating a sequence of tokens that corresponds to a layout, wherein the layout includes outlines allocated for and corresponding to a number of requested artworks; generating artwork embeddings of a plurality of artworks; sequentially selecting artworks to be placed in respective outlines in the layout based on the sequence of tokens in the layout the artwork embeddings of the previously selected artworks, wherein the selected artworks meet a pre-determined threshold of artistic quality; and displaying the requested wall of artworks, wherein the wall of artworks is a visual display of pieces of art arranged on a surface.

Certain embodiments disclosed herein also include a system for generating walls of artworks using at least one machine learning model. The system includes: a processing circuitry; and a memory, the memory containing instructions that, when executed by the processing circuitry, configure the system to: generate a sequence of tokens that corresponds to a layout, wherein the layout includes outlines allocated for and corresponding to a number of requested artworks; generate artwork embeddings of a plurality of artworks; sequentially select artworks to be placed in respective outlines in the layout based on the sequence of tokens in the layout the artwork embeddings of the previously selected artworks, wherein the selected artworks meet a pre-determined threshold of artistic quality; and display the requested wall of artworks, wherein the wall of artworks is a visual display of pieces of art arranged on a surface.

Certain embodiments disclosed herein include the method, non-transitory computer readable medium, or system noted above or below, wherein generating the sequence of tokens includes: generating a start-of-sequence token corresponding to a number of outlines in a requested layout; sequentially generating tokens in a sequence based on the previously generated tokens, wherein the start-of-sequence token is a previously generated token, and wherein each sequentially generated token includes the coordinates of at least one of the corners of each outline and the aspect ratio of each outline; and generating an end-of-sequence token.

Certain embodiments disclosed herein include the method, non-transitory computer readable medium, or system noted above or below, further including or being configured to perform the following step or steps: training a first machine learning model to generate layouts; and training a second machine learning model to generate walls of artworks based on the generated layouts.

Certain embodiments disclosed herein include the method, non-transitory computer readable medium, or system noted above or below, wherein training the first machine learning model to generate layouts includes: collecting a set of layouts, wherein each layout in the collected set of layouts is represented by a respective sequence of tokens, and wherein the collected set of layouts includes a plurality of layouts with varying numbers of outlines and configurations of the outlines; receiving a plurality of requests to create layouts for a range of artworks, wherein the range of artworks includes artworks of different number of outlines and configurations of the outlines; generating each requested layouts; and applying a loss function to each token in a sequence representing the layouts until the loss, computed by the loss function, is below a pre-determined threshold, wherein weights of the at least one machine learning model are updated with respect to each token in each sequence.

Certain embodiments disclosed herein include the method, non-transitory computer readable medium, or system noted above or below, wherein training the second machine learning model to generate layouts includes: receiving a layout with a specific number of outlines for artworks, wherein the layouts are represented as a sequence of tokens; sequentially selecting artworks based on the received layout and artwork embeddings of the previously generated artworks, wherein the artwork embeddings are generated using CLIP encodings; generating a wall of artworks; and applying a loss function to each token in a sequence representing the selected artworks until the average loss, computed by the loss function, is below a pre-determined threshold value, wherein weights of the at least one machine learning model are updated with respect to each token.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 illustrates a high-level view of the generation of a wall of artworks according to various disclosed embodiments.

FIG. 3 illustrates an example flowchart 300 of a layout generation inference phase according to an embodiment.

FIG. 4 illustrates an example flowchart 400 of an inference phase of a wall generation according to an embodiment.

FIG. 5 illustrates an example flowchart 500 of a layout training phase according to an embodiment

FIG. 6 illustrates an example flowchart 600 of a wall of artworks training phase according to an embodiment.

FIG. 7 is a non-limiting illustration of a generated wall of artwork 700 in a user's living room.

FIG. 8 is an example schematic diagram of a wall generator system 130 according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for generating walls of artworks. The generation of walls of artworks includes a unique multi-stage approach using various AI models in which layouts are generated and walls of artworks are subsequently and separately generated based on the generated layouts and a set of artworks. The structure of this multi-stage approach to generate walls of artworks allows the usage of fewer computer resources and lower processing time without sacrificing the artistic quality of the generated walls of artworks. A layout and a wall of artworks are defined hereinbelow.

Additionally, the disclosed training process is uniquely segmented into a layout training phase and a wall of artworks training phase. In the layout training phase, the various AI models learn to produce layouts. A layout is a geometric representation that includes outlines of where artwork will be placed on the wall given a specific number of artworks that are requested by a user to be included in the completed wall of artworks. The various AI models learn to execute this task based on training on a set of layouts that are pre-selected and pre-processed in a way to make the training process more efficient, which lessens the usage of computer resources.

In the wall of artworks training phase, the various AI models learn to produce full walls of artworks, which include artworks arranged in a layout. A wall of artworks is defined as a visual display of pieces of art arranged on a surface. The various AI models learn to execute this task based on training on a first set of layouts, which includes only the geometric representations of a wall of artworks, a second set of layouts, which includes full walls of artworks, and a set of artworks that are not arranged in a layout.

Further, the operations described herein cannot be practically performed using the human mind or by performing the operation using paper and pencil. The human mind is not equipped to generate walls of artworks, through the operations described herein, because the human mind is not equipped to analyze the large number of possible permutations of the layouts and the walls of artworks, particularly at speeds required to provide an operable solution. Therefore, the operations described herein by far exceeds any practical use of the human mind. Moreover, a human operator applies subjective criteria to select and arrange artworks on a wall, leading to results which are not consistent between different human operators, and often not consistent between the same human performing the same task repeatedly, and in particular at the speeds required to provide an operable solution. The walls of artworks are generated, according to the disclosed embodiments, based on objective standards and thresholds.

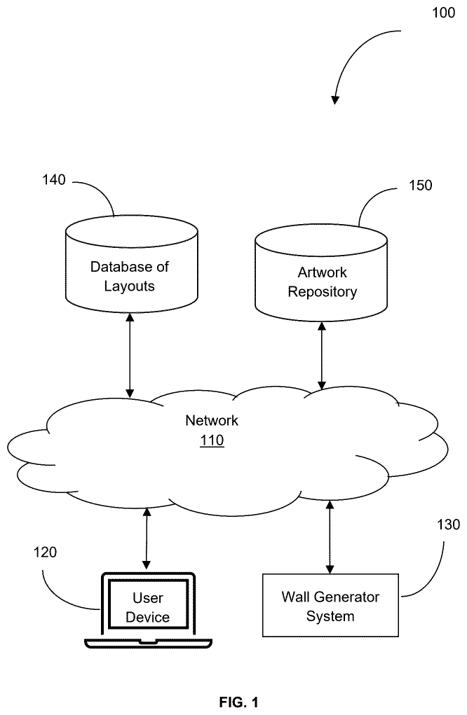

FIG. 1 shows an example network diagram 100 utilized to describe the various disclosed embodiments. In the example network diagram 100, a user device 120, a wall generator system 130, a database 140, and an artwork repository 150 communicate via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof. The embodiments disclosed herein with respect to the elements of the network diagram 100 and their interactions are merely used for instructional purposes and should not be construed as limiting examples.

The user device (UD) 120 may be, but is not limited to, a personal computer, a laptop, a tablet computer, a smartphone, a wearable computing device, or any other device capable of receiving and displaying notifications.

The UD 120 sends a request over the network 110 to the wall generator system 130 to generate a wall consisting of a specific number of artworks. The UD 120 includes a user interface, including but not limited to, a webpage, web portal, web application, or smartphone application, that allows the user to interact with the elements in the network diagram 100. The user may interact with the user interface of the UD 120 to send the request over the network 110 to the wall generator system 130. In another embodiment, the UD 120 stores the wall generator system 130 locally.

Additionally, the UD 120 is configured to receive a digital rendering of a wall of artworks that is generated by the wall generator system 130. A wall of artwork is defined above. The UD 120 also includes a means by which the user can purchase the wall of artworks that are digitally rendered.

The wall generator system 130 is configured to generate walls of artworks arranged according to various layouts. The wall generator system 130 receives layouts and artworks from the database 140 and the artwork repository 150, respectively, over the network 110. In some embodiments, the wall generator system 130 includes various artificial intelligence (AI) neural network architectures to generate walls of artworks, including but not limited to, decoder models and encoder-decoder models.

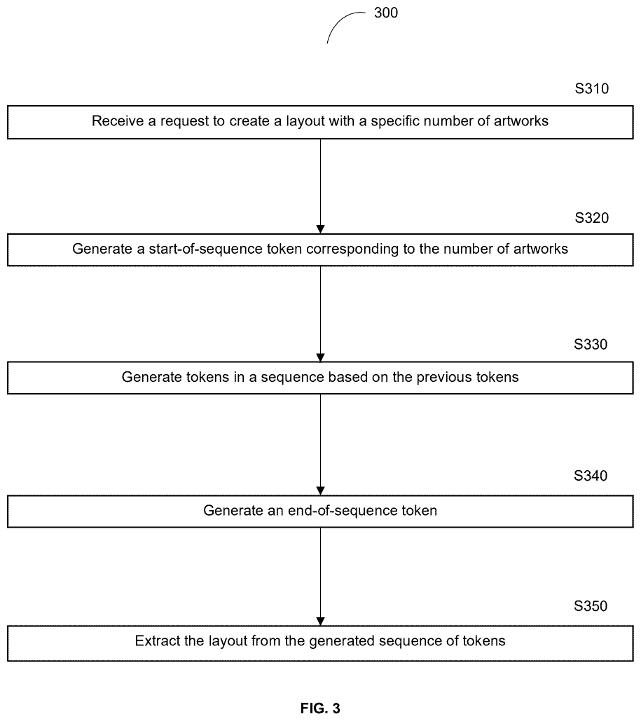

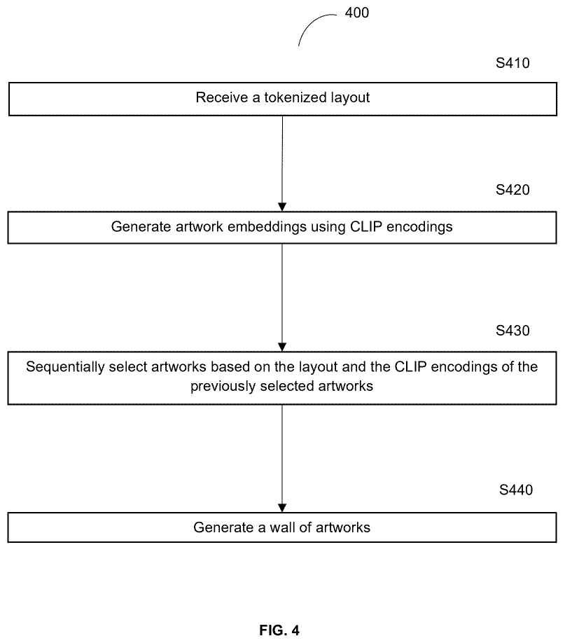

In an embodiment, a layout generation inference phase, discussed in more detail with respect to FIG. 3, includes the use of various AI models of the wall generator system 130. According to this embodiment, a layout, based on the number of artworks requested by the user via the UD 120, is generated via a decoder model. A wall of artworks inference phase, discussed in more detail with respect to FIG. 4, includes the use of various AI models of the wall generator 130. According to this embodiment, a complete wall of artworks is generated, via an encoder-decoder model, based on the generated layout and previously generated artworks (if any). The encoder and decoder models are AI-trained models that mimic the operation of large language models (LLMs) to pick and arrange artwork on walls. The operations of these models are discussed in detail below.

In an embodiment, artworks are selected by the wall generator system 130 by using contrastive language-image pre-training (CLIP) embeddings. The wall generator system 130 may include one or more neural network architectures that are trained to align visual and textual embeddings of the artworks. By utilizing CLIP embeddings, the neural network architectures can learn associations between visual content of the artworks and select artwork based on the encoded artwork's relationship with the encoded previously selected artworks 230 given a complete wall layout.

The database 140 includes layouts. The layouts in the database include a first set of layouts (e.g., layouts without artworks placed in allocated outlines in the layouts), and a second set of layouts (e.g., layouts with artworks placed in the allocated outlines in the layouts).

The artwork repository 150 includes artworks. Some artworks in the artwork repository 150 are included in the second set of layouts in the database 140 as described above. Other artworks are not included in the second set of layouts in database 140.

In an embodiment, database 140 and artwork repository 150 store their respective data on a shared storage. Such a configuration allows the database 140 and the artwork repository 150 to access and manage data within the same physical storage medium and allows for increased efficiency of the operations described herein, including the usage of fewer computer resources and lower processing time.

It should be understood that the embodiments disclosed herein are not limited to the specific architecture illustrated in FIG. 1, and other architectures may be equally used without departing from the scope of the disclosed embodiments. Specifically, the server 130 may reside in a cloud computing platform, a datacenter, and the like. Moreover, in an embodiment, there may be a plurality of servers operating as described hereinabove and configured to either have one as a standby, to share the load between them, or to split the functions between them.

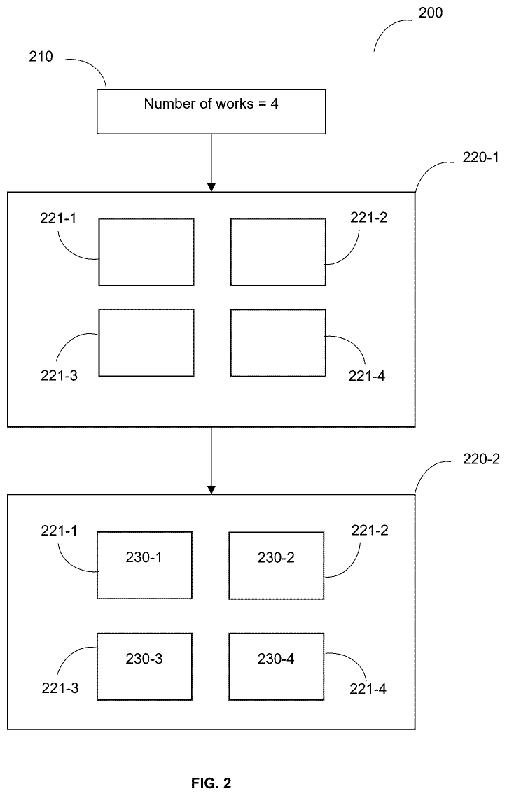

FIG. 2 illustrates a high-level view 200 of the generation of a wall of artworks. User request 210 is a request to generate a wall that includes four (4) artworks. The example shown in FIG. 2 is merely used for illustration purposes and the actual configuration of the layout and resulting artworks in the layout may be different than those illustrated in FIG. 2. Additionally, the user request 210 may include any number of artworks to be generated for the resulting wall of artworks.

Layout 220-1 is a geometric representation of a wall that includes four outlines 221-1, 221-2, 221-3, and 221-4 to accommodate four artworks to be placed into each outline of the layout. In other embodiments, the number of outlines in the layout corresponds to the number of artworks requested by the user request 210. In an embodiment, the layout is generated at the layout generation inference phase as described hereinbelow with respect to FIG. 3.

Layout 220-2 is a wall of artworks. Layout 220-2 includes the same geometric representation that was generated in the layout 220-1. In layout 220-2, however, the artworks 230-1 through 230-4 are placed into their respective outlines 221-1 through 221-4 in the layout 220-2, resulting in a completed wall of artworks.

The artworks 230-1 through 230-4 are selected based on the given layout 220-1 and the previously selected artworks (if any). As such, artwork 230-1 will be selected based on the layout 220-1. Then, artwork 230-2 is selected based on the layout 220-1 and the artwork 230-1. Artwork 230-3 is selected based on the layout 220-1, the artwork 230-1 and the artwork 230-2. Then, artwork 230-4 is selected based on the layout 220-1 and artworks 230-1 through 230-3. This sequential selection of artworks based on the layout 220-1 and the previously selected artworks continues until the number of artworks requested for the layout are selected.

FIG. 3. illustrates an example flowchart 300 of a layout generation inference phase according to an embodiment. The layout generation inference phase is defined as an inference phase of an AI model that is configured to generate layouts as defined herein and according to the disclosed embodiments. In an embodiment, the inference phase is executed by the wall generator system 130. In an embodiment, the layout generation inference phase is executed by at least one neural network architecture configured to transform encoded data into a tokenized format

At S310, a request to create a layout with a specific number of artworks is received. In an embodiment, the request is sent by a user via the UD 120 to the wall generator system 130. The user, via the UD 120, may specify their preference for the number of artworks in the layout, which corresponds to the number of artworks that will be placed in the completed wall of artworks.

In an embodiment, the user may specify various parameters including, but not limited to, styles of art, the presence or absence of a frame, a type of frame, the presence or absence of a border, a type of border, sizes of the artworks, a type of room in which the wall exists, and any furniture or items in the room.

At S320, a start-of-sequence (SOS) token corresponding to the number of specified artworks is generated. A SOS token signifies the beginning of a sequence of tokens that will be generated by the AI model. The SOS token is used to signal to the AI model to begin the generation process. In an embodiment, the SOS token is pre-defined as the number of artworks e.g., num_works is included in the AI model's vocabulary. For example, if the SOS token is [12], this token will provide context for the AI model to generate the subsequent token according to the value of 12 for the SOS token. This SOS token is generated directly from and based on the number of artworks specified by the user request via the UD 120. For example, a SOS token of [4] means that the number of artworks specified is four (4).

At S330, tokens are generated in a sequence based on the previously generated tokens, including the SOS token. For example, given a SOS token of [4], the second token generated in the sequence is based on the SOS token of [4]. In an embodiment, each subsequently generated token includes the coordinates of at least one of the corners of the artwork and the aspect ratio of the artwork, which indicates the position and size of the artwork, respectively.

In another embodiment, other tokens corresponding to an artwork are generated. Such tokens include but are not limited to, a token corresponding to frame type and a token corresponding to frame border.

In yet another embodiment, a matrix of probabilities of overlaps is used. According to this embodiment, the probability matrix is updated such that coordinates of outlines in the layout that were already generated are assigned a lower probability in the probability matrix than they were assigned before they were generated in the layout. Assigning these coordinates a lower probability serves to reduce the likelihood that they will be selected again. This reduction in likelihood ensures that the generated layout does not include outlines for artworks that overlap.

At S340, an end-of-sequence (EOS) token is generated. The EOS token signals to the AI model where the sequence concludes, ensuring that the output is properly terminated and that no additional, unnecessary tokens are generated or processed.

At S350, the layout is extracted from the generated sequence of tokens. Such tokens represent the coordinates of the geometric representation of the outlines in which artworks are to be placed. In an embodiment, the sequence of tokens that correspond to the coordinates of the layout are converted into a visual, geometrical depiction of the layout. For example, in an embodiment, this extracted layout is layout 220-1 depicted in FIG. 2.

FIG. 4 illustrates an example flowchart 400 of an inference phase of a wall generation according to an embodiment. The wall generation inference phase is defined as inference phase of an AI model that is configured to generate walls of artworks according to the disclosed embodiments herein. In an embodiment, the inference phase is executed by the wall generator system 130. In an embodiment, the wall generation inference phase uses at least one AI model that includes at least one neural network architecture configured to encode data and at least one neural network architecture configured to transform the encoded data into a tokenized format, including but not limited to, an encoder-decoder transformer model.

At S410, a tokenized layout is received. In an embodiment, the tokenized layout is the generated tokenized layout in FIG. 3.

At S420, artwork embeddings are generated using CLIP encodings. The use of CLIP encodings to generate artwork embeddings serves to capture visual representations of the artworks. In an embodiment, CLIP encodings are received and used as disclosed hereinabove with respect to FIG. 2, 230.

At S430, artworks are sequentially selected. In an embodiment, the selected artworks are in a tokenized format. Each artwork (e.g., each artwork in the artwork repository 150) is assigned a unique identification number that points to the associated artwork. In an embodiment, the number representation for each artwork is the tokenized format.

In an embodiment, artworks are selected based on the tokenized layout and the received CLIP encodings of the previously selected artworks, if any. The first artwork (for example, 230-1) is selected based on the tokenized layout only. The subsequently selected artworks are selected based on the tokenized layout and the token of the previously selected artworks.

The tokenized layout contains positional and size information regarding the coordinates of the outlines in which the artworks are to be placed. Therefore, each artwork is selected based on the positional and size information contained in tokenized layout and based on the tokens of any previously selected artworks.

In an embodiment, artworks are selected if the relationship between their respective CLIP encodings is such that a wall that includes the selected artworks meets a pre-determined threshold of artistic quality. For example, when three artworks are already selected, the fourth artwork selected must be an artwork with a sufficiently high probability of meeting this pre-determined threshold of artistic quality when selected as part of the completed wall of artwork.

The selection of artworks, according to this embodiment, is not based on how close to or far from one CLIP encoding is from another, but the selection is based on a learned relationship (through training, as disclosed in detail below) between their respective CLIP encodings that yields a wall of artwork that meets a pre-determined threshold of artistic quality.

CLIP encodings of artworks may be close in the embedding space. As a non-limiting, illustrative example, the CLIP encoding of artwork depicting a couple sitting on a bench will be close to the CLIP encodings of nearly identical artworks of couples sitting on benches. These CLIP encodings are representative of artworks that have similar features (e.g., composition and subject matter). On the other hand, CLIP encodings of artworks may be far from each other in the embedding space. As a non-limiting, illustrative example, the CLIP encoding of an artwork depicting a couple sitting on a bench will be far from the CLIP encoding in the embedding space of, as a non-limiting example, an abstract art painting.

However, it should be noted that, because two CLIP encodings are close does not mean that selecting artworks that correspond to these “close” CLIP encodings will meet the pre-determined threshold of artistic quality. Additionally, because two CLIP encodings are far does not mean that selecting artworks that correspond to these “far” CLIP encodings will not meet the pre-determined threshold of artistic quality.

In another embodiment, a matrix of probabilities of duplicates is used. According to this embodiment, the probability matrix is updated such that artworks that were already selected are assigned a lower probability in the probability matrix than they were assigned before they were generated in the layout. Assigning already selected artworks a lower probability serves to reduce the likelihood that they will be selected again e.g., be duplicated in the generated wall of artworks. For example, a layout may include five artworks and the second and fourth artworks selected will include floral depictions. The second artwork selected is artwork 300 (300 is the artwork's identification number). According to this embodiment, after artwork 300 is selected as the second artwork in the layout, it will be assigned a lower probability in the probability matrix such that it has a lower chance of being selected for the fourth artwork e.g., a duplicate.

At S440, a wall of artworks is generated. In an embodiment, the wall of artworks is generated by extracting the tokenized sequence into a visual representation (i.e., the resulting wall of artwork) based on the coordinates, aspect ratio, tokenized artworks, etc. In an embodiment, the generated wall of artworks is depicted as the layout 220-2 that includes artworks 230-1 through 230-4 in FIG. 2.

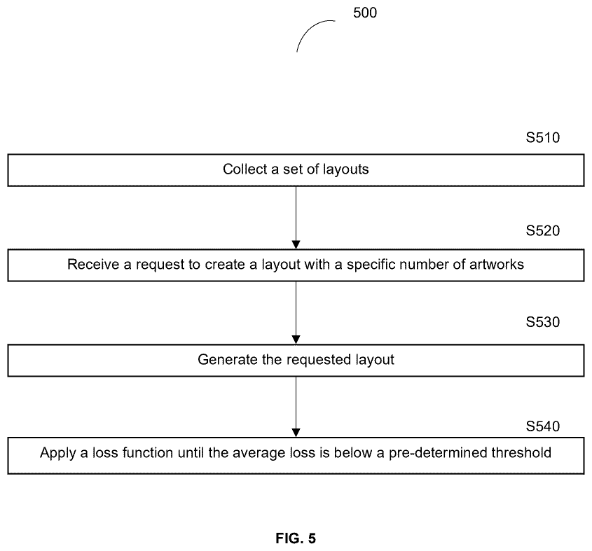

FIG. 5 illustrates an example flowchart 500 of a layout training phase according to an embodiment. In an embodiment, the training phase is part of the layout generation process of the wall generator system 130. In an embodiment, the layout training phase uses at least one AI model that includes at least one neural network architecture configured to transform encoded data into a tokenized format.

At S510, a set of layouts is collected. In an embodiment, the layouts are received by the wall generator system (e.g., system 130, FIG. 1) from the database 140 over the network 110. In an embodiment, the both the first and second sets of layouts are received. In another embodiment, the first set of layouts is received. The first and second sets of layouts are defined above with respect to FIG. 1.

In an embodiment, the layouts are tokenized. The tokenized layouts include the coordinates of at least one corner of each outline allocated for an artwork and the aspect ratio of each outline allocated for the artwork. In another embodiment, other tokens corresponding to an artwork are generated. Such tokens include but are not limited to, a token corresponding to frame type and a token corresponding to frame border.

In an embodiment, noise tokens are added to the tokenized layouts. Noise tokens refer to tokens that are introduced into a sequence to simulate errors or irrelevant information. In an embodiment, noise tokens can be used to make the AI model more robust by teaching it to handle and ignore irrelevant or incorrect data. For example, during the layout generation training phase, noise tokens may be randomly inserted into the sequences. The AI model then learns to identify and disregard these noise tokens, focusing only on the relevant tokens. This process helps improve the model's ability to generalize and perform well even when the input data contains some level of noise or corruption.

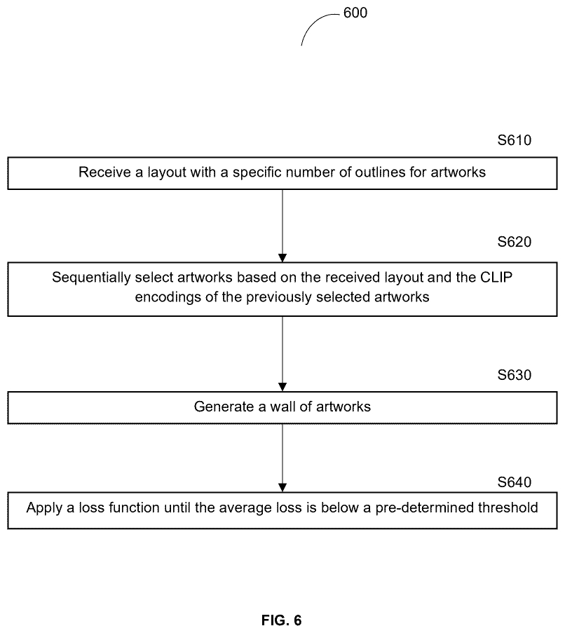

At S520, a request to create a layout with a specific number of artworks is received. The request is made as part of the training process. In an embodiment, requests are received for a pre-determined range of numbers of artworks. For training purposes, the requests may be to generate layouts containing two (2) artworks through “N” artworks. The requests are sent iteratively. It should be noted that, at the layout training phase, the requested layouts of a specific number of artworks is made to generate layouts that include outlines allocated for that specific number of artworks but does not select the artworks themselves. Training for the selection of artworks is explained with respect to the wall of artworks training phase in FIG. 6.

At S530, the requested layout is generated. The layout is generated as disclosed with respect to FIG. 3. In an embodiment, the generated layout is based on the layouts collected at S510. This generated layout is tokenized, in an embodiment, by the at least one AI model that includes at least one neural network architecture configured to transform encoded data into a tokenized format.

At S540, a loss function is applied. A loss function is a mathematical function that quantifies the difference between the predicted values and the true values. The goal during training is to minimize this loss, thereby improving the model's accuracy.

In an embodiment, the loss function is applied as an average of all losses calculated for a plurality of layouts with varying numbers of outlines and configurations of outlines. The loss function is calculated with respect to each token in the sequence of the generated layout. The weights of the AI model are updated with respect to each token in the sequence of the generated layout and are updated based on the average of all losses calculated for the plurality of various layouts. The weights of the AI model are updated iteratively until the loss, computed by the loss function, falls below a pre-determined threshold.

Requests for layouts with various outlines and configurations are received and new layouts are generated until the loss falls below a pre-determined threshold. This iterative loop is part of the training process and serves to train the at least one AI model to generalize. Through this process, the AI model learns which configurations of layouts meet a pre-determined threshold for artistic quality and which configurations of layouts do not meet such a pre-determined threshold.

FIG. 6 illustrates an example flowchart 600 of a wall of artworks training phase according to an embodiment. In an embodiment, the training phase is part of the wall generation process of the wall generator system 130. In an embodiment, the wall of artworks training phase uses at least one AI model that includes at least one neural network architecture configured to encode data and at least one neural network architecture configured to transform the encoded data into a tokenized format.

At S610, a layout with a specific number of outlines for artworks is received. In an embodiment, this received layout is a tokenized layout. In an embodiment, the number and configurations of the outlines in the layout is specified in a request. The request is made as part of the training process. In an embodiment, requests are received for a pre-determined range of numbers and configurations of artworks. For training purposes, the requests may be to generate walls containing two (2) artworks through “N” artworks and walls with “N” different configurations. The requests are sent iteratively.

At S620, artworks are selected sequentially based on the received layout and received CLIP encodings of the previously selected artworks, if any. The first artwork (for example, 230-1) is selected based on the tokenized layout only. The subsequently selected artworks are selected based on the tokenized layout and the CLIP encodings of the previously selected artworks. In an embodiment, this sequential selection of artworks is executed using an encoder-decoder model.

In an embodiment, the artworks are sequentially selected from a set of artworks (e.g., from the artwork repository 150). The encoder-decoder model has access to artwork that is part of a complete wall of artworks in a training dataset as well as artworks that are not part of a wall of artworks. Augmenting the training dataset with artworks that are independent of walls allows the encoder-decoder model to learn to generate walls of artworks to a higher threshold of artistic quality than it would generate if it were only trained on a set of walls of artworks.

At S630, a wall of artworks is generated. In an embodiment, the wall of artworks is generated by extracting the tokenized sequence into a visual representation (i.e., the resulting wall of artwork) based on the coordinates, aspect ratio, tokenized artworks, etc. In an embodiment, the generated wall of artworks is depicted as the layout 220-2 that includes artworks 230-1 through 230-4 in FIG. 2.

At S640, a loss function is applied. As noted above, a loss function is a mathematical function that quantifies the difference between the predicted values and the true values. The goal during training is to minimize this loss, thereby improving the model's accuracy.

In an embodiment, the loss function is applied as an average of all losses calculated for a plurality of layouts with varying numbers of outlines and configurations of outlines. The loss function is calculated with respect to each token in the sequence of the generated layout. The weights of the AI model are updated with respect to each token in the sequence of the generated layout and are updated based on the average of all losses calculated for the plurality of various layouts. The weights of the AI model are updated iteratively until the loss, computed by the loss function, falls below a pre-determined threshold.

Requests for layouts with various outlines and configurations is received and new layouts are generated until the loss falls below a pre-determined threshold. This iterative loop is part of the training process and serves to train the at least one AI model to generalize. Through this process, the AI model learns which configurations of layouts meet a pre-determined threshold for artistic quality and which configurations of layouts do not meet such a pre-determined threshold.

In an embodiment, the loss function teaches or adjusts the encoder-decoder model to select artworks that have a sufficiently high probability of being placed in the specific layout of artworks that were previously generated. In a further embodiment, the probability of the artwork need not be the highest probability amongst all the probabilities of the artworks, but a sufficiently high probability. This ensures that the model does not learn the training data too well, which would negatively impact its performance on new data. Instead, the model learns to select various artworks with a sufficiently high probability instead of merely “memorizing” the artwork with the highest probability every time.

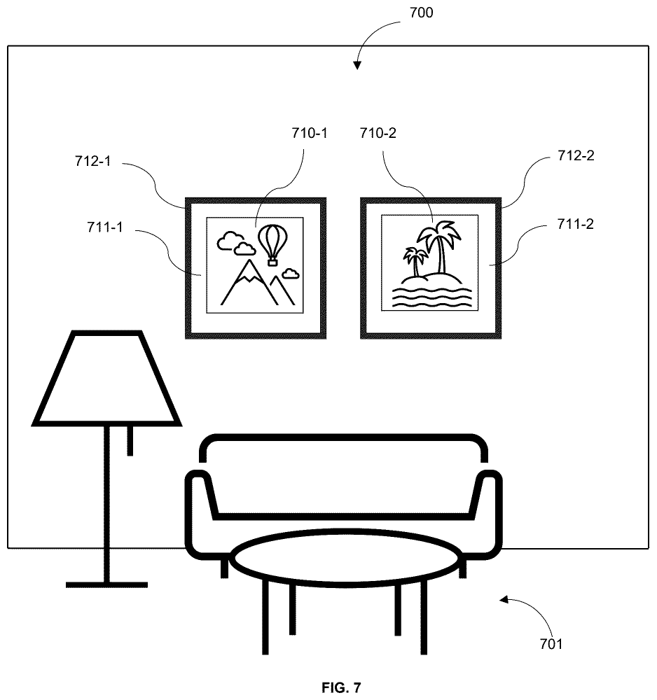

FIG. 7 is an non-limiting illustration of a generated wall of artwork 700 in a user's living room. The illustration shows a user's living room furniture 701 that is positioned beneath the wall of artwork 700.

The wall of artwork 700 depicts a layout of two (2) artworks 710-1 and 710-2. Border 711-1 is a border between the artwork 710-1 and frame 712-1. Similarly, border 711-2 is a border between the artwork 710-2 and frame 712-2. In an embodiment, the outlines of the layout are the dimensions of the frames 712-1 and 712-2.

The artworks 710-1 and 710-2 are placeholder artworks depicted merely for illustration purposes and do not limit the embodiments of the various artworks that can be selected to fill this particular layout in the wall of artwork 700.

In further embodiments, the user can select the size and type of frame as well as the size and type of the border for each selected artwork in the wall 700.

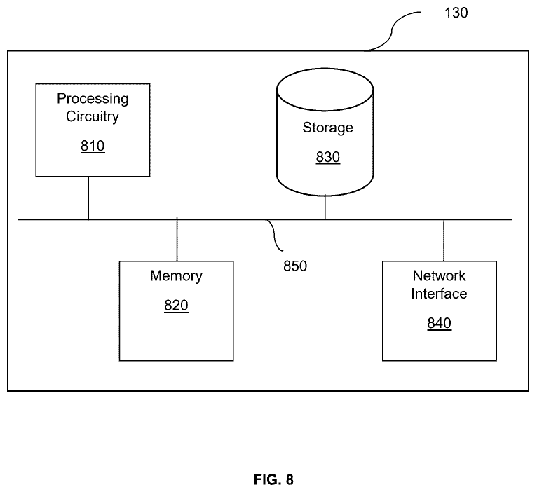

FIG. 8 is an example schematic diagram of a wall generator system 130 according to an embodiment. The system 130 includes a processing circuitry 810 coupled to a memory 820, a storage 830, and a network interface 840. In an embodiment, the components of the system 130 may be communicatively connected via a bus 850.

The processing circuitry 810 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 820 may be volatile (e.g., random access memory, etc.), non-volatile (e.g., read only memory, flash memory, etc.), or a combination thereof.

In one configuration, software for implementing one or more embodiments disclosed herein may be stored in the storage 830. In another configuration, the memory 820 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 810, cause the processing circuitry 810 to perform the various processes described herein.

The storage 830 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 840 allows the wall generator system 130 to communicate with, for example, the user device 120, the database 140 and repository 150, and the like.

It should be understood that the embodiments described herein are not limited to the specific architecture illustrated in FIG. 8, and other architectures may be equally used without departing from the scope of the disclosed embodiments.

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various embodiments disclosed herein can be implemented as hardware, firmware, software, or any combination thereof. Moreover, the software may be implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for generating walls of artworks using at least one machine learning model, comprising:
generating a sequence of tokens that corresponds to a layout, wherein the layout includes outlines allocated for and corresponding to a number of requested artworks;
generating artwork embeddings of a plurality of artworks;
sequentially selecting artworks to be placed in respective outlines in the layout based on the sequence of tokens in the layout the artwork embeddings of the previously selected artworks, wherein the selected artworks meet a pre-determined threshold of artistic quality; and
displaying the requested wall of artworks, wherein the wall of artworks is a visual display of pieces of art arranged on a surface.

2. The method of claim 1, wherein generating the sequence of tokens further comprises:
generating a start-of-sequence token corresponding to a number of outlines in a requested layout;
sequentially generating tokens in a sequence based on the previously generated tokens, wherein the start-of-sequence token is a previously generated token, and wherein each sequentially generated token includes the coordinates of at least one of the corners of each outline and the aspect ratio of each outline; and
generating an end-of-sequence token.

3. The method of claim 1, wherein artwork embeddings are generated through the use of Contrastive Language-Image Pre-training (CLIP) encodings.

4. The method of claim 2, further comprising:
initializing a matrix of probabilities of overlaps, wherein the matrix of probabilities of overlaps is initialized to assign probabilities to coordinates of the outlines of the layout; and
assigning the coordinates of the generated tokens with a reduced probability, wherein the probability is reduced below a pre-determined threshold value.

5. The method of claim 1, wherein the sequence of tokens include a token corresponding to frame border and a token corresponding to frame type.

6. The method of claim 1, wherein sequentially selecting artworks to be placed in respective outlines in the layout further comprises:
initializing a matrix of probabilities of duplicates, wherein the matrix of probabilities of duplicates is initialized to assign probabilities to artworks; and
assigning selected artworks with a reduced probability, wherein the probability is reduced below a pre-determined threshold value.

7. The method of claim 1, further comprising:
training a first machine learning model to generate layouts; and
training a second machine learning model to generate walls of artworks based on the generated layouts.

8. The method of claim 7, wherein training the first machine learning model to generate layouts further comprises:
collecting a set of layouts, wherein each layout in the collected set of layouts is represented by a respective sequence of tokens, and wherein the collected set of layouts includes a plurality of layouts with varying numbers of outlines and configurations of the outlines;
receiving a plurality of requests to create layouts for a range of artworks, wherein the range of artworks includes artworks of different number of outlines and configurations of the outlines;
generating each requested layouts; and
applying a loss function to each token in a sequence representing the layouts until the loss, computed by the loss function, is below a pre-determined threshold, wherein weights of the at least one machine learning model are updated with respect to each token in each sequence.

9. The method of claim 8, wherein sequences of tokens representing each layout comprise noise tokens, wherein the noise tokens simulate errors or irrelevant information.

10. The method of claim 7, wherein training the second machine learning model further comprises:
receiving a layout with a specific number of outlines for artworks, wherein the layouts are represented as a sequence of tokens;
sequentially selecting artworks based on the received layout and artwork embeddings of the previously generated artworks, wherein the artwork embeddings are generated using CLIP encodings;
generating a wall of artworks; and
applying a loss function to each token in a sequence representing the selected artworks until the average loss, computed by the loss function, is below a pre-determined threshold value, wherein weights of the at least one machine learning model are updated with respect to each token.

11. A non-transitory computer readable medium having stored thereon instructions for causing a processing circuitry to execute a process, the process comprising:
generating a sequence of tokens that corresponds to a layout, wherein the layout includes outlines allocated for and corresponding to a number of requested artworks;
generating artwork embeddings of a plurality of artworks;
sequentially selecting artworks to be placed in respective outlines in the layout based on the sequence of tokens in the layout the artwork embeddings of the previously selected artworks, wherein the selected artworks meet a pre-determined threshold of artistic quality; and
displaying the requested wall of artworks, wherein the wall of artworks is a visual display of pieces of art arranged on a surface.

12. A system for generating walls of artworks using at least one machine learning model, comprising:
a processing circuitry; and
a memory, the memory containing instructions that, when executed by the processing circuitry, configure the system to:
generate a sequence of tokens that corresponds to a layout, wherein the layout includes outlines allocated for and corresponding to a number of requested artworks;
generate artwork embeddings of a plurality of artworks;
sequentially select artworks to be placed in respective outlines in the layout based on the sequence of tokens in the layout the artwork embeddings of the previously selected artworks, wherein the selected artworks meet a pre-determined threshold of artistic quality; and
display the requested wall of artworks, wherein the wall of artworks is a visual display of pieces of art arranged on a surface.

13. The system of claim 12, wherein the one or more processors, when generating the sequence of tokens, are configured to:
generate a start-of-sequence token corresponding to a number of outlines in a requested layout;
sequentially generate tokens in a sequence based on the previously generated tokens, wherein the start-of-sequence token is a previously generated token, and wherein each sequentially generated token includes the coordinates of at least one of the corners of each outline and the aspect ratio of each outline; and
generate an end-of-sequence token.

14. The system of claim 13, wherein the one or more processors are further configured to:
initialize a matrix of probabilities of overlaps, wherein the matrix of probabilities of overlaps is initialized to assign probabilities to coordinates of the outlines of the layout; and
assign the coordinates of the generated tokens with a reduced probability, wherein the probability is reduced below a pre-determined threshold value.

15. The system of claim 12, wherein artwork embeddings are generated through the use of Contrastive Language-Image Pre-training (CLIP) encodings.

16. The system of claim 12, wherein the sequence of tokens include a token corresponding to frame border and a token corresponding to frame type.

17. The system of claim 12, wherein the one or more processors, when sequentially selecting artworks to be placed in respective outlines in the layout, are configured to:
initialize a matrix of probabilities of duplicates, wherein the matrix of probabilities of duplicates is initialized to assign probabilities to artworks; and
assign selected artworks with a reduced probability, wherein the probability is reduced below a pre-determined threshold value.

18. The system of claim 12, wherein the one or more processors are further configured to:
train a first machine learning model to generate layouts; and
train a second machine learning model to generate walls of artworks based on the generated layouts.

19. The system of claim 18, wherein the one or more processors, when training the first machine learning model to generate layouts, are configured to:
collect a set of layouts, wherein each layout in the collected set of layouts is represented by a respective sequence of tokens, and wherein the collected set of layouts includes a plurality of layouts with varying numbers of outlines and configurations of the outlines;
receive a plurality of requests to create layouts for a range of artworks, wherein the range of artworks includes artworks of different number of outlines and configurations of the outlines;
generate each requested layouts; and
apply a loss function to each token in a sequence representing the layouts until the loss, computed by the loss function, is below a pre-determined threshold, wherein weights of the at least one machine learning model are updated with respect to each token in each sequence.

20. The system of claim 19, wherein the one or more processors, when sequences of tokens representing each layout, are configured to noise tokens, wherein the noise tokens simulate errors or irrelevant information.

21. The system of claim 18, wherein the one or more processors, when training the second machine learning model, are configured to:
receive a layout with a specific number of outlines for artworks, wherein the layouts are represented as a sequence of tokens;
sequentially select artworks based on the received layout and artwork embeddings of the previously generated artworks, wherein the artwork embeddings are generated using CLIP encodings;
generate a wall of artworks; and
apply a loss function to each token in a sequence representing the selected artworks until the average loss, computed by the loss function, is below a pre-determined threshold value, wherein weights of the at least one machine learning model are updated with respect to each token.
